(19) United States
(12) Patent Application Publication
(10) Pub. No.: US 2025/0208882 A1
(43) Pub. Date: Jun. 26, 2025

(54) SYSTEM AND METHOD FOR DISCOVERING AND REMEDIATING ENDPOINTS HAVING SOFTWARE AND CONFIGURATION INCOMPLIANCE

(71) Applicant: SAUDI ARABIAN OIL COMPANY, Dhahran (SA)

(72) Inventors: Mohammad Abdallah Al Mohsin, Saihat (SA); Mahmoud Ali Al Jarrash, Al Qatif (SA); Adel Abdulfattah Marghalani, Dammam (SA)

(73) Assignee: SAUDI ARABIAN OIL COMPANY, Dhahran (SA)

(21) Appl. No.: 18/396,347

(22) Filed: Dec. 26, 2023

(51) Int. Cl. G06F 9/445; G06F 11/30

(52) U.S. Cl. CPC G06F 9/44505; G06F 11/3006; G06F 11/3051

(57) ABSTRACT

A method for discovering and remediating endpoints not conforming to software and configuration requirements, is disclosed. In the method, after generating an inventory of a plurality of endpoints, a compliance state of each of the plurality of endpoints for a compliance definition is determined based on a compliance rule, and a list of a plurality of incompliant endpoints is generated based on the compliance state of each of the plurality of endpoints. Then, one or more remediation actions are associated with each of the plurality of incompliant endpoints in the list, and the list is traversed to perform the one or more remediation actions associated with each incompliant endpoint in the list. If a result of the one or more remediation actions has an incomplete value, a more aggressive remediation action is performed with each endpoint associated with the result with the incomplete value.

### BACKGROUND

Many endpoints (e.g., end user devices) are used to perform functions in a business today. Over a period of time, some endpoints may become incompliant with the policies and standards such as being unable to meet specific software or configuration requirements. Further, these incompliant endpoints may be missing mandatory software updates, have corrupted software, or be misconfigured.

These incompliant endpoints may be unstable such that the endpoints become unusable or vulnerable to cyberattacks. However, remediation measures for incompliant endpoints taken by an individual may be time consuming and costly. Accordingly, there exists a need for a system and method for automatically discovering and remediating incompliant endpoints.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to discovering and remediating endpoints not conforming to software and configuration requirements.

In general, in one aspect, embodiments disclosed herein relate to a method for device incompliance remediation includes: generating an inventory of a plurality of endpoints; determining a compliance state of each of the plurality of endpoints for a compliance definition based on a compliance rule; generating a first list of a first plurality of incompliant endpoints based on the compliance state of each of the plurality of endpoints; associating one or more remediation actions with each of the plurality of incompliant endpoints in the first list; traversing the first list to perform the one or more remediation actions associated with each incompliant endpoint in the first list; in response to a result of the one or more remediation actions having an incomplete value, adding an endpoint associated with the result to a second list of a second plurality of the incompliant endpoints; associating an additional remediation action with each incompliant endpoint in the second list; traversing the second list to perform the additional remediation action with each incompliant endpoint in the second list; and in response to a second result of the additional remediation actions having the incomplete value, incrementing an attempt counter.

In one or more embodiments, the method further includes generating a request for manual remediation in response to the attempt counter reaching a predetermined number.

In one or more embodiments, in the method, the one or more remediation actions comprise at least one of installing a software, starting a service, setting a value of a parameter, creating a file, deleting a file, and running a script. The one or more remediation actions are categorized into a plurality of levels. The additional remediation action comprises a level from the plurality of levels. The level is increased for each increase of the attempt counter. The compliance definition comprises an encryption compliance and an operating system patching compliance. The compliance state is one of compliant, incompliant, unknown, and inapplicable. The compliance rule comprises a compliance scope that determines whether the compliance rule applies to each of the plurality of endpoints. The request is tracked through a ticketing system. An endpoint associated with the second result of the additional remediation actions having the complete value is removed from the second list in response to the second result of the additional remediation actions having a complete value.

In general, in one aspect, embodiments disclosed herein relate to a system for remediating software and configuration incompliance includes a plurality of endpoints, and a server configured to: establish an inventory of a plurality of endpoints; determine a compliance state of each of the plurality of endpoints for a compliance definition based on a compliance rule; generate a first list of a first plurality of incompliant endpoints based on the compliance state; associate one or more remediation actions with each incompliant endpoint in the first list; traverse the first list to perform the one or more remediation actions associated with each incompliant endpoint in the first list; when a result of the one or more remediation actions having an incomplete value, adding an endpoint associated with the result of the one or more remediation actions having the incomplete value to a second list of a second plurality of the incompliant endpoints; associate additional remediation actions with each incompliant endpoint in the second list; traversing the second list to perform the additional remediation action with each incompliant endpoint in the second list; and when a second result of the additional remediation actions having the incomplete value, incrementing an attempt counter.

In one or more embodiments, in the system, the one or more remediation actions comprise at least one of installing a software, starting a service, setting a value of a parameter, creating a file, deleting a file, and running a script. The one or more remediation actions are categorized into a plurality of levels. The additional remediation action comprises a level from the plurality of levels. The level is increased for each increase of the attempt counter. The compliance definition comprises an encryption compliance and an operating system patching compliance. The compliance state is one of compliant, incompliant, unknown, and inapplicable. The compliance rule comprises a compliance scope that determines whether the compliance rule applies to each of the plurality of endpoints.

In general, in one aspect, embodiments disclosed herein relate to a non-transitory computer readable medium (CRM) storing instructions performs operation of remediating software and configuration incompliance. The operation includes: establishing an inventory of a plurality of endpoints; determining a compliance state of each of the plurality of endpoints for a compliance definition based on a compliance rule; generating a first list of a first plurality of incompliant endpoints based on the compliance state; associating one or more remediation actions with each incompliant endpoint in the first list; traversing the first list to perform the one or more remediation actions associated with each incompliant endpoint in the first list; in response to a result of the one or more remediation actions having an incomplete value, adding an endpoint associated with the result of the one or more remediation actions having the incomplete value to a second list of a second plurality of the incompliant endpoints; associating an additional remediation action with each incompliant endpoint in the second list; traversing the second list to perform the additional remediation action with each incompliant endpoint in the second list; and in response to a second result of the additional remediation actions having the incomplete value, incrementing an attempt counter.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 illustrates a system for discovering and remediating endpoints not conforming to software and configuration requirements according to one or more embodiments.

FIG. 2 illustrates a data structure of a compliance rule in accordance with one or more embodiments.

FIG. 3 illustrates a data structure of a remediation action in accordance with one or more embodiments.

FIG. 4 illustrates a data structure of a remediation request in accordance with one or more embodiments.

FIG. 5 illustrates a flowchart of a method for discovering and remediating endpoints according to one or more embodiments.

FIG. 6 illustrates a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

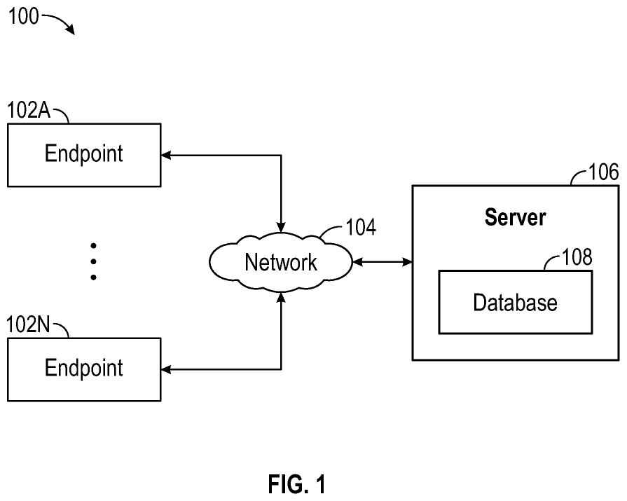

In the following description of FIGS. 1-6, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a wellbore” includes reference to one or more of such wellbores.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

An endpoint is a user device, for example a laptop or a desktop, connected to a server via a network. Over a period of time, some of the endpoints among many endpoints used in a business may become outdated such that these endpoints may be incompliant with standards and policies. For example, policies may require all endpoints to have a certain software version installed or have endpoints encrypted with a certain version of an algorithm. However, incompliant endpoints may deviate from cybersecurity and operational standards by missing standard software updates, having standard software in an unhealthy state, or having missing or wrong configurations.

Although remediation actions are applied, some endpoints may stay incompliant because of the following reasons: turning off power of endpoints; being online briefly with not enough time for patches to get downloaded and installed; endpoints not being used for a while but still counted as incompliant; having issues with patch installation; and/or having issues with a configuration manager such as System Center Configuration Manager (SCCM).

One or more embodiments disclosed herein relate to discovering and remediating endpoints not conforming to software and configuration requirements. Embodiments of disclosure may provide at least one of the following advantages: having stable endpoints; protecting sensitive information; and avoiding excessive financial cost.

FIG. 1 illustrates a system (100) for discovering and remediating endpoints not conforming to software and configuration requirements according to one or more embodiments. The system (100) includes one or more endpoints (102A) through (102N) and a server (106). The endpoints (102A) through (102N) and the server (106) may be interconnected by way of a network (104). The network (104) may be, for example, a wide area network (WAN), a local area network (LAN), and/or the internet. In addition, the network (104) may be comprised of several networks such as an LTE or 5G network connected via the internet to a company LAN. Further, endpoints (102A) through (102N) may utilize a tunnel, such as a Virtual Private Network (VPN) to access the server (106). To utilize the VPN or other security protocol, endpoints (102A) through (102N) may be required to perform authentication or otherwise provide user credentials.

In one or more embodiments, server (106) may have a database (108). The database (108) may include a master inventory that includes endpoints from inventory sources. For example, an inventory source is a system, in which endpoint online or offline inventory is maintained (e.g., directory services, asset management, software license tracking, endpoint protection, vulnerability management, and configuration management systems). For example, the inventory source may be Microsoft Active Directory, Microsoft Endpoint Configuration Manager, or IT Asset Management System.

In one or more embodiments, endpoints (102A) through (102N) are maintained via an inventory source, and are listed in a master inventory included in database (108). For example, server (106) may traverse the network (104) to discover new endpoints in an inventory source such as polling active endpoints on the network (104), and may list any newly discovered endpoints in database (108). Alternatively, when a new endpoint comes online on network (104), the new endpoint may register itself with an inventory source, and may notify server (106) to be added to the list in the database (108).

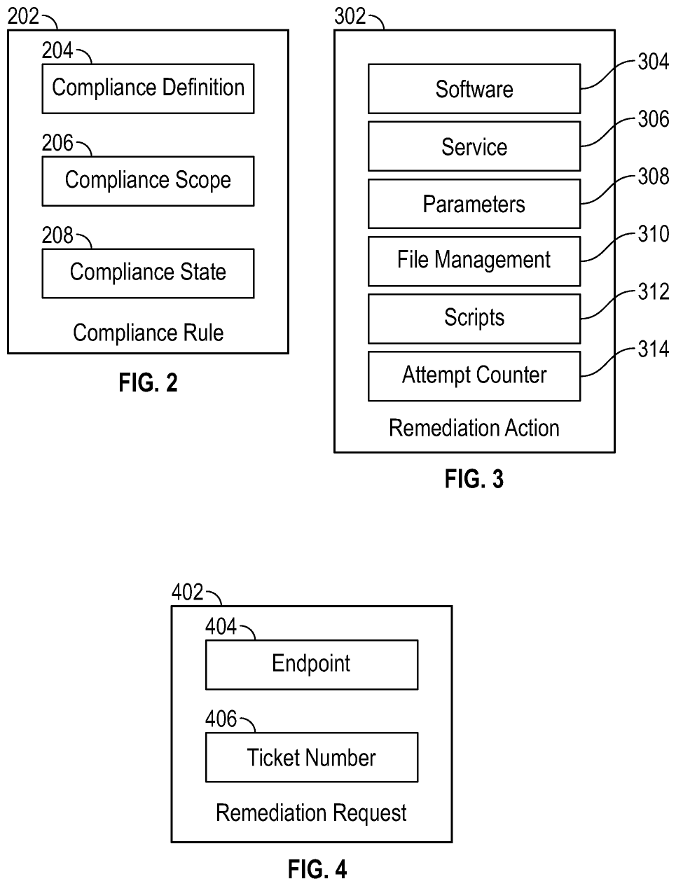

Additionally, server (106) may poll endpoints in the master inventory included in database (108) for various status by retrieving a compliance rule, and may determine the compliance of each endpoint. The compliance rule is described below with respect to FIG. 2. For example, database such as Microsoft SQL Database may be used to store the master inventory and compliance state.

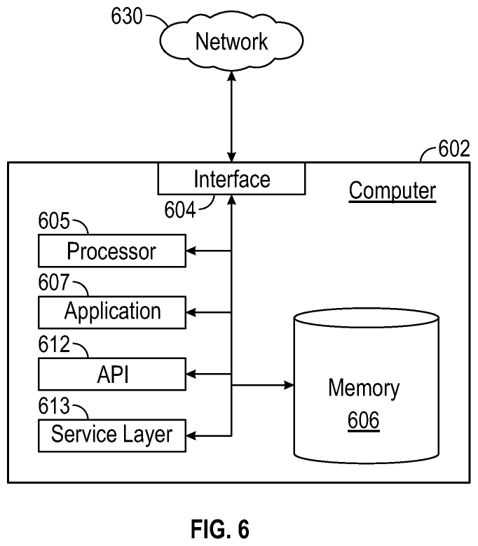

In one or more embodiments, endpoints (102A) through (102N) may be desktops, laptops, tablets, servers, smartphones, or an Internet-of-things (IoT) device. In some embodiments, endpoints (102A) through (102N) and server (106) may be implemented in one or more computers such as a computer described with reference to FIG. 6.

FIG. 2 illustrates a data structure of a compliance rule (202) in accordance with one or more embodiments. Compliance rule (202) may be stored in server (106), for example, in database (108).

Compliance rule (202) may include data fields such as a compliance definition (204), a compliance scope (206), and a compliance state (208). Compliance definition (204) may be a set of conditions or requirement that determines whether an endpoint is compliant with a specific policy or standard. Compliance definition (204) may include an encryption compliance and an operating system patching compliance. For example, an endpoint would be compliant with an encryption standard if its storage device (e.g., solid state drive and/or hard disk drive) is encrypted with one or more specific encryption algorithms, cypher suites, and a minimum key length. An endpoint would be compliant with an operating system patching if it has all applicable patches released by an operating system vendor.

Compliance scope (206) may be a set of compliance rules or criteria to determine whether a specific compliance rule (202) is applicable to an endpoint. For example, a compliance scope for a VPN compliance, which is to check whether a VPN client is installed, may be applicable to only mobile devices or laptops. Additionally or alternatively, a compliance scope may be applicable by a region, a specific department of a company, or a specific clearance level.

Compliance state (208) may be a compliance result of an endpoint for a specific compliance. For example, a compliance state of an endpoint for a specific compliance may be one of compliant, incompliant, unknown, and inapplicable. Additionally, a compliant state is a state in which an endpoint may satisfy one or more conditions defined by the compliance definition (204). An incompliant state is a state in which an endpoint may not satisfy one or more conditions of the compliance definition (204). An unknown state is a state in which an endpoint may not been evaluated for compliance conditions. For example, if an endpoint have not been connected to a network recently, it may not have been evaluated for compliance. An inapplicable state is a state in which an endpoint may not fall within compliance scope (206).

FIG. 3 illustrates a data structure of a remediation action (302) in accordance with one or more embodiments. Remediation action (302) may be stored in server (106), for example, in database (108). For example, database such as Microsoft SQL Database may be used to store remediation actions and results.

Remediation action (302) may include data fields such as a software (304), a service (306), parameters (308), file management (310), scripts (312), and an attempt counter (314). The data fields in remedy action (302) may specify what needs to be done in order for an endpoint to be compliant with a specific compliance rule such as installing a specific software specified in software (304), starting a service specified in service (306), setting one or more values of parameters defined in parameters (308), creating a file or deleting a file according to an instruction for file management (310), or running one or more scripts specified in scripts (312).

For example, a remediation action (302) may be installing software specified in software (304) such as installing all patches released by operating system (OS) vendors, application software vendors, or hardware vendors for firmware, basic input output system (BIOS) or drivers. In addition, a remediation action (302) may be setting values specified in parameters (308) such as setting expected values for specific system configurations or parameters. Further, a remediation action (302) may be performing a file operation specified in file management (310) such as encrypting storage devices based on approved algorithms and/or parameters. Additionally, a remediation action (302) may be running a script specified in scripts (312) such as setting a password on the BIOS, setting a proper boot device order, or disabling certain boot devices. Moreover, a remediation action (302) may be running services specified in service (306) such as setting all OS security hardening configurations and OS operational configurations for business application compatibility, and setting application software security hardening configuration and application software operational configurations for business application compatibility.

In one or more embodiments, the data fields in remediation action (302) may be categorized into multiple levels so that the first level of the remedy action (302) is performed first before trying the next level of remediation actions. For example, remediation action (302) may be categorized into five levels: (1) software, (2) service, (3) parameters, (4) file management (5) scripts, and may perform actions corresponding to the software level before performing actions corresponding to the service level.

For example, when an incompliant endpoint has multiple levels of remediation actions for the same incompliance, the following levels of remediation actions are attempted sequentially: clean disk to free up space; restart patching agent; clear patching store cache; reboot the endpoint; repair pathing agent; uninstall and reinstall patching agent; rebuild system files; redeploy the operating system. A next level of remediation action may be attempted only if the endpoint is still incompliant after completion of the above levels of remediation actions.

For example, suppose an endpoint has incompliant OS patches. If the endpoint is from an inventory source (e.g., active directory), a number of missing patches from the endpoints is checked. If the number is over a threshold, the endpoints may be re-imaged. If not, the state of a patching agent (e.g., SCCM) is checked. If the patching agent is not active, the patching agent is restarted and/or re-installed. Then, an online state of the endpoint is checked. If the endpoint is not online, the endpoint is rebooted. Once the endpoint is online, patches are installed if the endpoint has enough disk space. If the endpoint does not have enough disk space, disk space is freed up and patches are installed.

If the actions require a user permission, a user interaction may be prompted before performing the actions. Additionally, an attempt counter (314) is incremented when a remediation action is unsuccessful or is not able to be attempted, and the level may be increased as a result.

FIG. 4 illustrates a data structure of a remediation request (402) in accordance with one or more embodiments. Remediation request (402) may be stored in server (106), for example, in database (108).

Remediation request (402) may include data fields such as an endpoint (404) and the ticket number (406). For example, when the attempt counter (314) in FIG. 3 reaches a predetermined number, a request for manual remediation is generated. The request is, then, tracked through a ticketing system via endpoint (404) that requires a manual remediation and ticket number (406) generated for the request for manual remediation. In one or more embodiments, a request for manual remediation for an endpoint may be generated before attempting any remediation actions. For example, a ticket number for manual remediation request is generated, and is tracked after exhausting all levels of remediations actions and/or reaching the remediation attempt threshold.

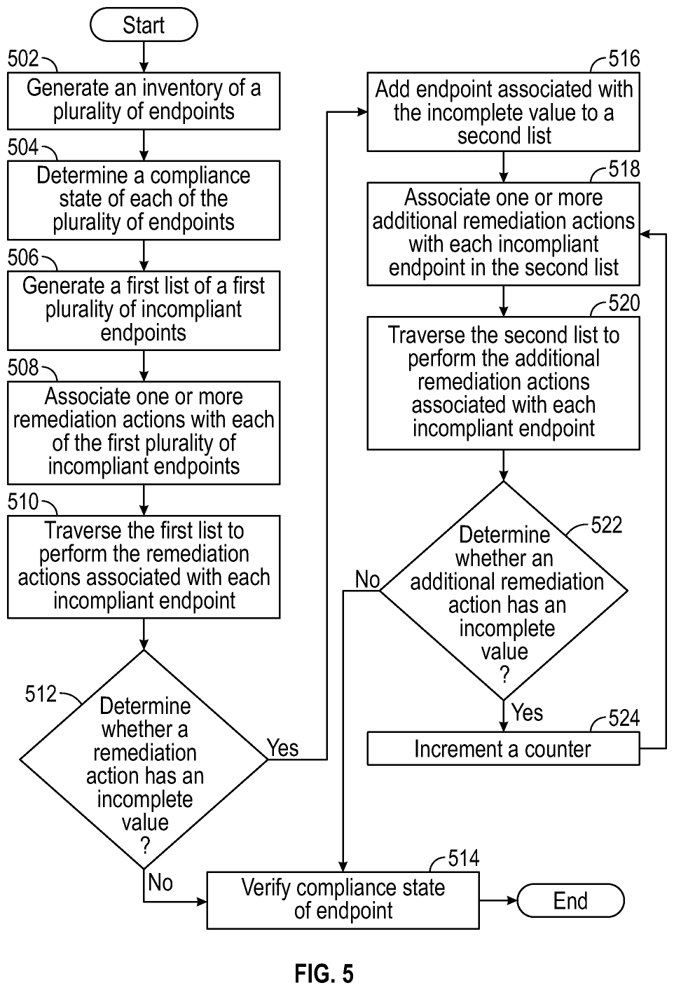

FIG. 5 illustrates a flowchart of a method (500) for discovering and remediating endpoints according to one or more embodiments. More specifically, FIG. 5 depicts a new method to automatically discover and remedy endpoints that may be incompliant based on one or more compliance rules. In one or more embodiments, one or more of the steps shown in FIG. 5 may be omitted, repeated, and/or performed in a different order than the order shown in FIG. 5. Accordingly, the scope of the invention should not be considered limited to the specific arrangement of steps shown in FIG. 5. Steps 502 to 524 shown in FIG. 5 are explained below.

In Step 502, a server, such as the server (106) of FIG. 1, generates an inventory of a plurality of endpoints such as endpoints (102A) through (102N) of FIG. 1. The inventory may include a plurality of the endpoints maintained via, for example, directory services, asset management, software license tracking, endpoint protection, vulnerability management, or configuration management systems. Further, the server may traverse the network polling for active endpoints to establish the inventory.

In Step 504, a compliance state of each of the plurality of endpoints is determined using a compliance rule. For example, a server retrieves one or more compliance rules including a compliance definition and a compliance scope for an endpoint in the inventory, checks against the compliance scope whether a compliance rule applies to the endpoint, and determines the compliance state of the endpoint based on the compliance definition. Additionally, once the compliance state is determined, the state is written in a data structure (e.g., an applicable compliance rule or in the inventory maintained in a database). Further, an endpoint may be determined to be as one of compliant, incompliant, unknown, and inapplicable for the compliance definition such as encryption compliance or operating system patching compliance based on the compliance scope.

In Step 506, a first list of a first plurality of incompliant endpoints is generated based on the compliance state of each of the plurality endpoints. For example, if an endpoint is determined to be incompliant in Step 504, the incompliant endpoint is added to a list of incompliant endpoints.

In Step 508, one or more remediation actions are associated with each of the plurality of the incompliant endpoints in the first list. For example, in order to remediate incompliance, one or more remediation actions, which are appropriate to each endpoint, such as installing software updates and security patches, running a script, and applying encryption, in the incompliant list, are scheduled.

In Step 510, the first list is traversed to perform the one or more remediation actions associated with each incompliant endpoint in the first list. For example, scheduled remediation actions are performed on each endpoint in the incompliant list. For example, a server may initiate an installation process for software update and security patches on an incompliant endpoint in the list of incompliant endpoints. Additionally, the server may run a script remotely on an incompliant endpoint in the list of incompliant endpoints. Further, the server may initiate encryption on storages in an incompliant endpoint in the list of incompliant endpoints.

In Step 512, if a result of the one or more remediation actions has a complete value, the process moves to Step 514. If the result of the one or more remediation actions is incomplete, the process moves to Step 516. In one or more embodiments, the process may also move to Step 516 as the result of, for example, an unknown result of the one or more remediation actions.

In Step 514, the endpoint that is the subject of the completed remediation action is verified for compliance and if found to be compliant the process ends for that endpoint. If the endpoint that is the subject of the completed remediation action is found to be incompliant, then the process may attempt to repeat the remediation action (e.g., Steps 508-512) or move to Step 516.

In Step 516, an endpoint associated with the result of the one or more remediation actions having the incomplete value is added to a second list of a second plurality of the incompliant endpoints. For example, if the result of the one or more remediation actions performed on an endpoint in Step 510 is incomplete, the endpoint with the incomplete result will be added to the second incompliant list. In other words, in Step 516 a second list of incompliant endpoints is generated that have had a remediation action attempted that was not able to be completed.

In Step 518, one or more additional remediation actions are associated with each incompliant endpoint in the second list. For example, additional remediation actions, which are more aggressive and different from the previous remediation action, are scheduled to perform each endpoint in the second incompliant list.

In Step 518, an attempt counter may also be checked against a threshold. If the attempt counter exceeds a threshold value (which may be predetermined or configurable) then a ticket is generated for operator intervention or override. In other words, the additional or more aggressive remediation action may be a ticketed operator intervention, and this may end the process for a particular endpoint. In this case, performance of one or more scheduled remediation actions may be stopped, and a user or an operator (e.g., personnel from the IT department) may perform one or more remediation actions such as installing software, running scripts, and applying encryption manually on the incompliant endpoint. In other words, one or more embodiments may advantageously allow for the automation of repeated and/or escalating remediation attempts such that IT resources may be deployed more efficiently only in circumstances where a predetermined threshold is met. Alternatively or additionally, there may be other additional remediation actions to be taken where the process continues.

In Step 520, the second list is traversed to perform the additional remediation action(s) associated with each incompliant endpoint in the second list.

In Step 522, if a result of the one or more remediation actions has a complete value, the process moves to Step 514 such that the compliance state of the subject endpoint may be verified before ending the process for that endpoint. If the result of the one or more remediation actions is incomplete, the process moves to Step 524. In one or more embodiments, the process may also move to Step 524 as the result of, for example, an unknown result of the one or more remediation actions.

In Step 524, an attempt counter is incremented for the endpoint with the incomplete result and the process returns to Step 518 for further remediation attempts. In one or more embodiments, the attempt counter may also take the form of, for example, a timer where a remaining time value may be assigned for remediation before a manual remediation ticket may be generated. Additionally or alternatively, the attempt counter may also be related to a level of a remediation action such that additional remediation actions may be triggered as a result of incrementing the attempt counter. In other words, the attempt counter may be linked to escalating levels of remediation actions.

Those skilled in the art will appreciate that the above Steps 502-524 are described with reference to the system for discovering and remediating endpoints having software and configuration, and that such steps may be performed programmatically. For example, the above Steps 502-524 may be performed individually or by any combination of endpoints (102A) through (102N), server (106), and database (108). Further, above Steps 502-524 may be performed iteratively over each endpoint.

Further, one or more embodiments disclosed herein for operating a system for discovering and remediating endpoints having software and configuration, for example with reference to FIG. 5, may be implemented on virtually any type of computer system, regardless of the platform being used. For example, the computer system may be one or more mobile devices (e.g., laptop computer, smart phone, personal digital assistant, tablet computer, or other mobile device), desktop computers, servers, blades in a server chassis, or any other type of computer system that includes at least the minimum processing power, memory, and input and output device(s) to perform one or more embodiments of the invention.

An example of the computer system is described with reference to FIG. 6, in accordance with one or more embodiments. FIG. 6 is a block diagram of a computer system used to provide computational functionalities associated with described algorithms, methods, functions, processes, flows, and procedures as described in the instant disclosure, according to an implementation. The illustrated computer (602) in the computer system is intended to encompass any computing device such as a server, desktop computer, laptop/notebook computer, wireless data port, smart phone, personal data assistant (PDA), tablet computing device, one or more processors within these devices, one or more internet of things (IoT) devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613)). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer (613). Software services, such as those provided by the service layer (613), provide reusable, defined business functionalities through a defined interface. For example, the interface may be software written in JAVA, C++, Python, or other suitable language providing data in extensible markup language (XML) format or other suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

In one embodiment, the file synchronization priority level and linked policy can be implemented as a software module that is installed on the cloud storage server or a standalone software module that can integrate with cloud storage service via the API (612).

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602). In one example, the method described with reference to FIG. 6 may be implemented by the application (607).

There may be any number of computers (602) associated with, or external to, a computer system containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602). Furthermore, in one or more embodiments, the computer (602) is a non-transitory computer readable medium (CRM).

In some embodiments, the computer system (602) is implemented as part of a cloud computing system. For example, a cloud computing system includes one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which are performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

For purposes of this disclosure, any element mentioned in the singular also includes the plural.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for device incompliance remediation, the method comprising:
generating an inventory of a plurality of endpoints;
determining a compliance state of each of the plurality of endpoints for a compliance definition based on a compliance rule;
generating a first list of a first plurality of incompliant endpoints based on the compliance state of each of the plurality of endpoints;
associating one or more remediation actions with each of the plurality of incompliant endpoints in the first list;
traversing the first list to perform the one or more remediation actions associated with each incompliant endpoint in the first list;
in response to a result of the one or more remediation actions having an incomplete value, adding an endpoint associated with the result to a second list of a second plurality of the incompliant endpoints;
associating an additional remediation action with each incompliant endpoint in the second list;
traversing the second list to perform the additional remediation action with each incompliant endpoint in the second list; and
in response to a second result of the additional remediation actions having the incomplete value, incrementing an attempt counter.

2. The method according to claim 1, wherein the one or more remediation actions comprise at least one of installing a software, starting a service, setting a value of a parameter, creating a file, deleting a file, and running a script.

3. The method according to claim 1, wherein the one or more remediation actions are categorized into a plurality of levels.

4. The method according to claim 3, wherein the additional remediation action comprises a level from the plurality of levels.

5. The method according to claim 4, wherein the level is increased for each increase of the attempt counter.

6. The method according to claim 1, wherein the compliance definition comprises an encryption compliance and an operating system patching compliance.

7. The method according to claim 1, wherein the compliance state is one of compliant, incompliant, unknown, and inapplicable.

8. The method according to claim 1, wherein the compliance rule comprises a compliance scope that determines whether the compliance rule applies to each of the plurality of endpoints.

9. The method according to claim 1, further comprising: generating a request for manual remediation in response to the attempt counter reaching a predetermined number.

10. The method according to claim 9, wherein the request is tracked through a ticketing system.

11. The method according to claim 1, wherein in response to the second result of the additional remediation actions having a complete value, an endpoint associated with the second result of the additional remediation actions having the complete value is removed from the second list.

12. A system for remediating software and configuration incompliance, the system comprising:
a plurality of endpoints; and
a server configured to:
establish an inventory of a plurality of endpoints;
determine a compliance state of each of the plurality of endpoints for a compliance definition based on a compliance rule;
generate a first list of a first plurality of incompliant endpoints based on the compliance state;
associate one or more remediation actions with each incompliant endpoint in the first list;
traverse the first list to perform the one or more remediation actions associated with each incompliant endpoint in the first list;
when a result of the one or more remediation actions having an incomplete value, adding an endpoint associated with the result of the one or more remediation actions having the incomplete value to a second list of a second plurality of the incompliant endpoints;
associate additional remediation actions with each incompliant endpoint in the second list;
traversing the second list to perform the additional remediation action with each incompliant endpoint in the second list; and
when a second result of the additional remediation actions having the incomplete value, incrementing an attempt counter.

13. The system according to claim 12, wherein the one or more remediation actions comprise at least one of installing a software, starting a service, setting a value of a parameter, creating a file, deleting a file, and running a script.

14. The system according to claim 12, wherein the one or more remediation actions are categorized into a plurality of levels.

15. The system according to claim 14, wherein the additional remediation action comprises a level from the plurality of levels.

16. The system according to claim 15, wherein the level is increased for each increase of the attempt counter.

17. The system according to claim 12, wherein the compliance definition comprises an encryption compliance and an operating system patching compliance.

18. The system according to claim 12, wherein the compliance state is one of compliant, incompliant, unknown, and inapplicable.

19. The system according to claim 12, wherein the compliance rule comprises a compliance scope that determines whether the compliance rule applies to each of the plurality of endpoints.

20. A non-transitory computer readable medium (CRM) storing instructions for performing operation of remediating software and configuration incompliance, the operation comprising:
establishing an inventory of a plurality of endpoints;
determining a compliance state of each of the plurality of endpoints for a compliance definition based on a compliance rule;
generating a first list of a first plurality of incompliant endpoints based on the compliance state;
associating one or more remediation actions with each incompliant endpoint in the first list;
traversing the first list to perform the one or more remediation actions associated with each incompliant endpoint in the first list;
in response to a result of the one or more remediation actions having an incomplete value, adding an endpoint associated with the result of the one or more remediation actions having the incomplete value to a second list of a second plurality of the incompliant endpoints;
associating an additional remediation action with each incompliant endpoint in the second list;
traversing the second list to perform the additional remediation action with each incompliant endpoint in the second list; and
in response to a second result of the additional remediation actions having the incomplete value, incrementing an attempt counter.
